(19) United States
(12) Patent Application Publication
(10) Pub. No.: US 2025/0257697 A1
(43) Pub. Date: Aug. 14, 2025

(54) GAS TURBINE CONTROL DEVICE AND GAS TURBINE CONTROL METHOD

(71) Applicant: MITSUBISHI HEAVY INDUSTRIES, LTD., Tokyo (JP)

(72) Inventors: Yusuke HAZUI, Tokyo (JP); Masumi NOMURA, Tokyo (JP); Shigeru ANO, Tokyo (JP); Koshiro FUKUMOTO, Tokyo (JP); Ryoichi HAGA, Tokyo (JP); Kenta WADA, Tokyo (JP)

(21) Appl. No.: 18/857,011

(22) PCT Filed: May 26, 2023
(86) PCT No.: PCT/JP2023/019602

§ 371 Date: Oct. 15, 2024

(30) Foreign Application Priority Data
Jun. 15, 2022 (JP) 2022096221

(51) Int. Cl. F02C 9/00

(52) U.S. Cl. CPC F02C 9/00; F05D 2270/334

(57) ABSTRACT

A gas turbine control device including a frequency analysis unit, a database, a combustion state prediction unit, and a correction amount calculation unit. The frequency analysis unit performs a frequency analysis of the vibration of a pressure or an acceleration inside a combustor, at an operation point specified by a process amount of the gas turbine, and outputs a frequency analysis result. The database stores the frequency analysis result and the process amount as analysis data for each operation point. The combustion state prediction unit predicts a combustion state using a prediction model constructed using analysis data. When a search start condition is met that defines the elapse of a wait time which is set based on past search records in an operation point region including an operation point, the correction amount calculation unit calculates a correction amount to be added to a control signal for the gas turbine.

### TECHNICAL FIELD

The present disclosure relates to a gas turbine control device and a gas turbine control method.

The present application claims priority based on Japanese Patent Application No. 2022-096221 filed in Japan on Jun. 15, 2022, the contents of which are incorporated herein by reference.

### BACKGROUND ART

In a gas turbine driven by using a combustion gas generated by a combustor, based on an output of a generator connected to the gas turbine, an ambient air temperature, or a humidity, a flow rate of a fuel or of air supplied to the combustor to generate the combustion gas is determined in advance. Values thereof are finely adjusted in a trial run, and are used for an operation. However, the trial run is actually performed in a limited period of time. Therefore, the value adjustment which takes all weather conditions into consideration cannot be achieved by the trial run. In addition, performance of a compressor for compressing the air supplied to the gas turbine may deteriorate, or a filter for removing foreign substances contained in the air may suffer aging defects including clogging. Therefore, there is a probability that an actual flow rate deviates from a planned flow rate or an adjusted flow rate in the trial run. In this case, there is a probability that combustion stability of the gas turbine is lowered, and that a combustion state of the gas turbine may deviate from a management range. There is a probability that this deviation of the combustion state from the management range leads to a malfunction such as a failure of the turbine, and the malfunction greatly hinders an operation of the gas turbine. Therefore, from the viewpoint of protecting the gas turbine and improving an operation rate, it is desirable to suppress and avoid the deviation of the combustion state from the management range as much as possible.

For example, PTL 1 discloses a technique for suppressing this deviation of the combustion state from the management range in the gas turbine. In PTL 1, based on a result obtained by performing frequency analysis on vibration of a pressure or of acceleration inside the combustor of the gas turbine, characteristics of combustion vibration are analyzed as the combustion state, and the flow rate of the fuel supplied to the combustor or the flow rate of the air is adjusted so that the combustion vibration is suppressed within the management range. Furthermore, adjusted process values are accumulated in a database, and subsequently, accumulated data in the database is used to improve reliability when the flow rate of the fuel or the flow rate of the air is adjusted to suppress the combustion vibration.

### CITATION LIST

### Patent Literature

[PTL 1] Japanese Unexamined Patent Application Publication No. 2005-155590

### SUMMARY OF INVENTION

### Technical Problem

In this type of gas turbine control device, when an operating point of the gas turbine is moved to suppress the combustion state within the management range as disclosed in PTL 1, surrounding operating points are searched for by automatically increasing or decreasing a fuel flow rate so that the combustion state is stabilized within the management range, and characteristic data relating to the combustion state at the operating points is collected. In this manner, more information can be accumulated in the database to improve the reliability. From the viewpoint of ascertaining the characteristics of the combustion state with high reliability, based on the information accumulated in the database in this way, it is desirable that information acquired under various operating conditions is accumulated in the database.

However, as described above, data collected at the operating points searched for while the fuel flow rate is automatically increased or decreased within the management range of the combustion state is extremely similar. Even when the same search is performed many times, only the similar data is collected, and it is difficult to collect various data. In contrast, when the operating point is searched for to collect various data, the combustion state deviates from the management range, thereby causing an increased probabilityprobability of the combustion vibration.

At least one embodiment of the present disclosure is made in view of the above-described circumstances, and aims to provide a gas turbine control device and a gas turbine control method which can collect various characteristic data while maintaining a combustion state within a management range.

Solution to Problem

According to at least one embodiment of the present disclosure, in order to solve the above-described problems, there is provided a gas turbine control device including a frequency analysis unit for outputting a frequency analysis result by performing a frequency analysis on vibration of a pressure or of acceleration inside a combustor of a gas turbine at operating points specified by a process amount of the gas turbine, a database for storing the frequency analysis result and the process amount as analysis data for each of the operating points, a combustion state prediction unit for predicting a combustion state of the gas turbine by using a prediction model constructed by using the analysis data, and a correction amount calculation unit for calculating a correction amount to be added to a control signal of the gas turbine to operate the gas turbine at a search candidate point where the combustion state predicted by the state prediction unit falls within a management range, out of search candidate points in which the operating point is a start point, when a search start condition defining an elapse of a waiting time set based on a past search result in an operating point region including the operating point is satisfied.

According to at least one embodiment of the present disclosure, in order to solve the above-described problems, there is provided a gas turbine control method including a step of outputting a frequency analysis result by performing a frequency analysis on vibration of a pressure or of acceleration inside a combustor of a gas turbine at operating points specified by a process amount of the gas turbine, a step of storing the frequency analysis result and the process amount as analysis data for each of the operating points, a step of predicting a combustion state of the gas turbine by using a prediction model constructed by using the analysis data, and a step of calculating a correction amount to be added to a control signal of the gas turbine to operate the gas turbine at a search candidate point where the combustion state predicted by the state prediction unit falls within a management range, out of search candidate points in which the operating point is a start point, when a search start condition defining an elapse of a waiting time set based on a past search result in an operating point region including the operating point is satisfied.

### Advantageous Effects of Invention

According to at least one embodiment of the present disclosure, it is possible to provide a gas turbine control device and a gas turbine control method which can efficiently collect analysis data used to construct a prediction model for predicting characteristics relating to combustion stability of a gas turbine while maintaining an operating state of the gas turbine within a management range.

### BRIEF DESCRIPTION OF DRAWINGS

FIG. 1 is a view schematically illustrating a configuration of a gas turbine according to an embodiment.

FIG. 2 is a block diagram functionally illustrating a gas turbine control device according to the embodiment together with the gas turbine.

FIG. 3 is a block diagram illustrating a detailed functional configuration of the gas turbine control device in FIG. 2.

FIG. 4 is a flowchart of a turbine control method executed by the gas turbine control device in FIG. 3.

FIG. 5 is an example of a result obtained by performing a frequency analysis on a pressure fluctuation in Step S101 in FIG. 4.

FIG. 6 is a view schematically illustrating a first virtual space defined by a process amount of the gas turbine.

FIG. 7 is a view schematically illustrating a second virtual space defined by the process amount of the gas turbine.

FIG. 8 is a view schematically illustrating a third virtual space defined by the process amount of the gas turbine.

### DESCRIPTION OF EMBODIMENTS

Hereinafter, some embodiments of the present invention will be described with reference to the accompanying drawings. Meanwhile, configurations described in the embodiments or illustrated in the drawings are not intended to limit the scope of the invention, and are merely examples for description.

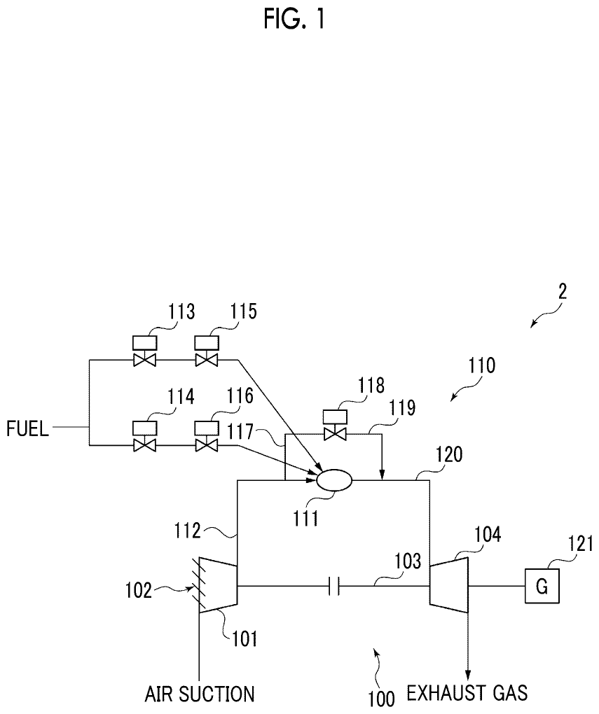

First, a gas turbine 2 serving as a control target of a gas turbine control device according to at least one embodiment of the present disclosure will be described. FIG. 1 is a view schematically illustrating a configuration of the gas turbine 2 according to the embodiment. The gas turbine 2 includes a gas turbine body part 100 and a combustion unit 110.

The gas turbine body part 100 includes a compressor 101 having an inlet guide vane 102, a rotary shaft 103, and a turbine 104. The compressor 101 and the turbine 104 are connected by a rotary shaft 103, and a generator 121 is connected to the turbine 104.

A combustion gas introduction pipe 120 is connected to the turbine 104. A combustion gas introduced from the combustion gas introduction pipe 120 drives the turbine 104, and the combustion gas (exhaust gas) used for work is discharged to an outside. The turbine 104 is driven by the combustion gas to convert energy of the combustion gas into rotational energy. The rotational energy of the turbine 104 is used to drive the compressor 101 and the generator 121 which are connected to the turbine 104.

The compressor 101 introduces air (intake) from the outside to generate compressed air, and feeds the generated compressed air to the combustor 111 via a compressed air introduction unit 112. In addition, the compressor 101 is connected to the turbine 104 and the generator 121 via a rotary shaft 103, and can be driven by the rotational energy of the turbine 104. The generator 121 is driven in this way to convert the rotational energy into electrical energy.

The inlet guide vane 102 is a rotary vane on an air introduction side of the compressor 101. The inlet guide vane 102 controls an angle of the rotary vane so that a flow rate of the air introduced into the compressor 101 can be adjusted even when a rotation speed is substantially constant.

The combustion unit 110 includes the compressed air introduction unit 112, a bypass air introduction pipe 117, a bypass valve 118, a bypass air mixing pipe 119, a combustion gas introduction pipe 120, the combustor 111, a main fuel flow control valve 113, a pilot fuel flow control valve 114, a main fuel supply valve 115, and a pilot fuel supply valve 116.

The compressed air introduction unit 112 is connected to the compressor 101, and is configured to guide the compressed air generated by the compressor to the combustor 111. The bypass air introduction pipe 117 and the bypass air mixing pipe 119 are configured to mix the combustion gas generated in the combustor 111 in such a manner that a portion of the compressed air introduced by the compressed air introduction unit 112 is introduced into the combustion gas introduction pipe 120 by bypassing the combustor 111. The bypass air introduction pipe 117 is connected to the compressed air introduction unit 112 on an upstream side of the combustor 111, and the bypass air mixing pipe 119 is connected to the combustion gas introduction pipe 120 on a downstream side of the combustor 111. In addition, a bypass valve 118 for adjusting a flow rate of the compressed air bypassing the combustor 111 is provided between the bypass air introduction pipe 117 and the bypass air mixing pipe 119.

The main fuel flow control valve 113 is configured to control a flow rate of a main fuel supplied to a main burner (not illustrated) of the combustor 111. The main fuel supply valve 115 is configured to control a supply state (on/off) of the main fuel to the main burner of the combustor 111.

The pilot fuel flow control valve 114 is configured to control a flow rate of a pilot fuel supplied to a pilot burner (not illustrated) of the combustor 111. The pilot fuel supply valve 116 is configured to control a supply state (on/off) of the pilot fuel to the pilot burner of the combustor 111.

The combustor 111 is connected to the compressed air introduction unit 112 for supplying the compressed air, a pipe connected to the main fuel supply valve 115 for supplying the main fuel, a pipe connected to the pilot fuel supply valve 116 for supplying the pilot fuel, and the combustion gas introduction pipe 120 for feeding the combustion gas. In the combustor 111, the compressed air introduced from the compressed air introduction unit 112, and the main fuel and the pilot fuel are respectively supplied and combusted to generate a high-temperature and high-pressure combustion gas. The generated combustion gas is fed to the turbine 104 via the combustion gas introduction pipe 120.

One end of the combustion gas introduction pipe 120 is connected to the combustor 111, and the other end is connected to the turbine 104. In addition, the bypass air mixing pipe 119 is connected to an intermediate portion of the combustion gas introduction pipe 120.

Subsequently, a gas turbine control device 1 for controlling the gas turbine 2 having the above-described configuration will be described. For example, the gas turbine control device 1 is configured to include a central processing unit (CPU), a random-access memory (RAM), a read-only memory (ROM), and a computer-readable storage medium. As an example, a series of processes for realizing various functions are stored in the storage medium in a form of a program. The CPU reads the program in the RAM, and executes information processing and arithmetic processing. In this manner, various functions are realized. A form installed in advance in the ROM or other storage medium, a form provided in a state of being stored in a computer-readable storage medium, or a form of being delivered via wired or wireless communication means may be applied as the program. The computer-readable storage medium is a magnetic disc, a magneto-optical disc, a CD-ROM, a DVD-ROM, or a semiconductor memory.

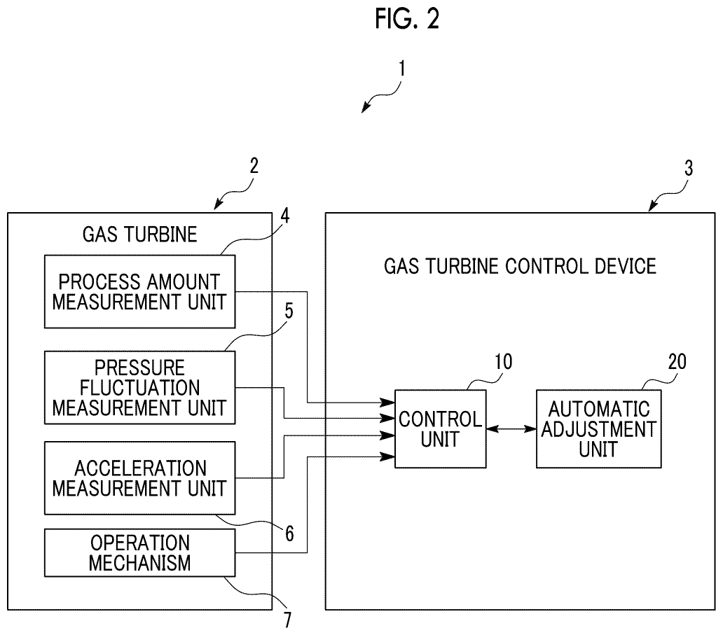

FIG. 2 is a block diagram functionally illustrating the gas turbine control device 1 according to the embodiment together with the gas turbine 2. The gas turbine 2 includes a process amount measurement unit 4, a pressure fluctuation measurement unit 5, an acceleration measurement unit 6, and an operation mechanism 7, as configurations relating to the control performed by the gas turbine control device 1.

The process amount measurement unit 4 has a configuration for measuring a process amount indicating an operating condition or an operating state during an operation of the gas turbine 2, and represents various measurement devices. The process amount measurement unit 4 is installed in an appropriate portion on the gas turbine 2, and a measurement result thereof is output to a controller 10 of the gas turbine control device 1 at each predetermined time interval. Here, for example, the process amount is generated power (generated current and generated voltage) of the generator 121, an air temperature and humidity around the gas turbine 2, a fuel flow rate and pressure in each part of the gas turbine 2, an air flow rate and pressure, a combustion gas temperature in the combustor 111, a combustion gas flow rate, a combustion gas pressure, a rotation speed of the compressor 101 or the turbine 104, and concentration of emission including nitrogen oxide (NOx) contained in an exhaust gas of the turbine 104 and carbon monoxide (CO).

Here, in addition to an operable “operation amount” such as the amount of the fuel or the air supplied to the gas turbine 2, the process amount measurement unit 4 may measure “the amount in an inoperable state”, for example, such as meteorological data including an air temperature and a magnitude (MW) of a load of the generator determined at a request (in this case, the “process amount” includes “an operation amount (plant data)” and “the amount in an inoperable state”).

The pressure fluctuation measurement unit 5 is a pressure measurement device attached to the combustor 111. The pressure fluctuation measurement unit 5 outputs a pressure fluctuation measurement value inside the combustor 111 which is generated by combustion at each predetermined time interval, to the gas turbine control device 1 in accordance with a command from the controller 10.

The acceleration measurement unit 6 is an acceleration measurement device attached to the combustor 111. The acceleration measurement unit 6 measures acceleration of the combustor 111 which is generated by combustion at each predetermined time interval, in accordance with a command from the controller 10, and outputs a measurement value thereof to the gas turbine control device 1.

The operation mechanism 7 is a mechanism that operates opening degrees of the main fuel flow control valve 113, the main fuel supply valve 115, the pilot fuel flow control valve 114, and the pilot fuel supply valve 116 in accordance with a command from the controller 10. In this manner, the operation mechanism 7 controls the flow rates of the main fuel and the pilot fuel. In addition, the operation mechanism 7 operates an opening degree of the bypass valve 118 in accordance with a command from the controller 10, and controls the flow rate of the air supplied to the combustor 111. Specifically, in the combustor 111, the flow rate of the air supplied to the combustor 111 is controlled by increasing (or decreasing) the opening degree of the bypass valve 118 and by increasing (or decreasing) the air flow rate flowing to the bypass side. In addition, the operation mechanism 7 operates an angle of the rotary vane of the inlet guide vane 102 in accordance with a command from the controller 10, and controls the flow rate of the air introduced into the compressor 101.

The gas turbine control device 1 includes the controller 10 and an automatic adjustment unit 20. The controller 10 receives measurement values output from the process amount measurement unit 4, the pressure fluctuation measurement unit 5, and the acceleration measurement unit 6, and transfers the measurement values to the automatic adjustment unit 20. In addition, based on a command from the automatic adjustment unit 20, the controller 10 outputs signals for operating the main fuel flow control valve 113, the main fuel supply valve 115, the pilot fuel flow control valve 114, the pilot fuel supply valve 116, the bypass valve 118, and the inlet guide vane 102, which are operation targets, to the operation mechanism 7.

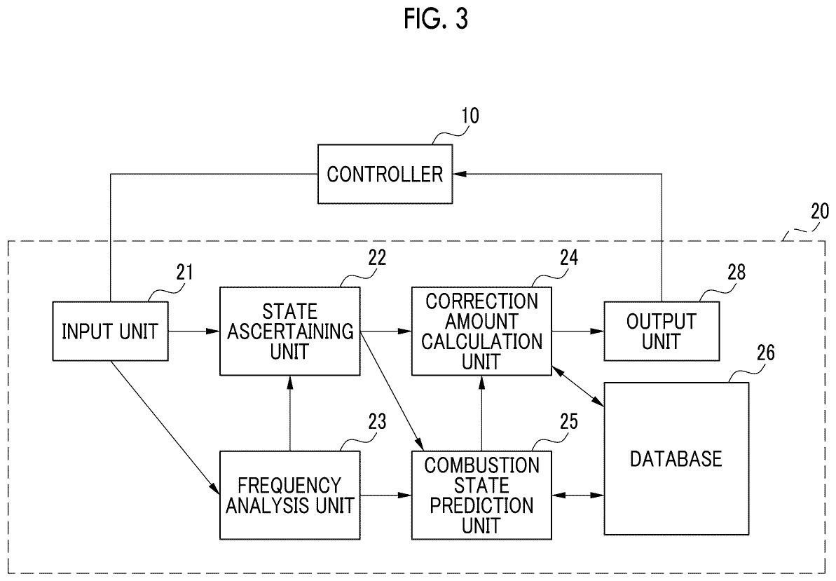

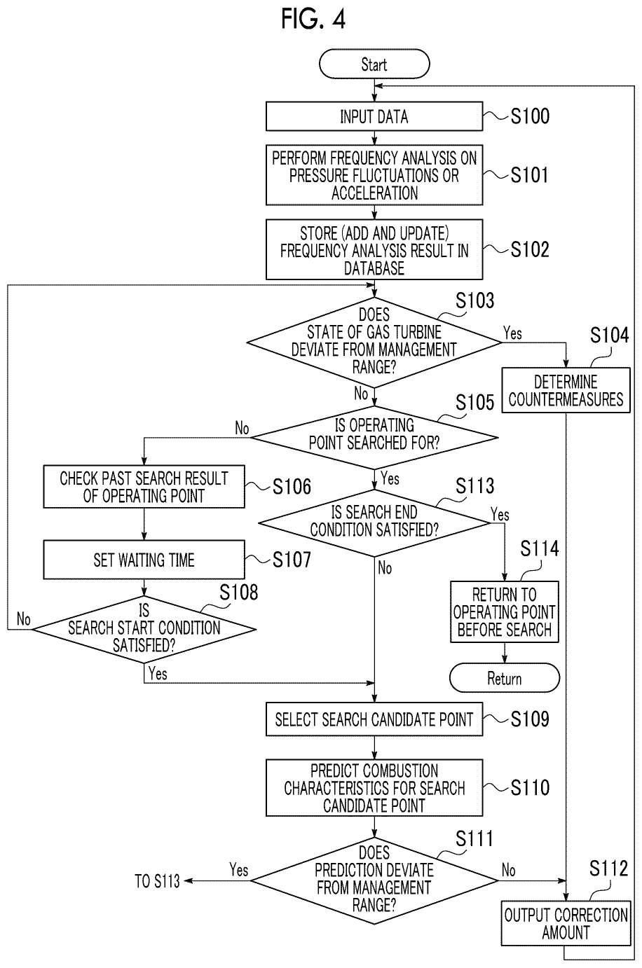

FIG. 3 is a block diagram illustrating a detailed functional configuration of the gas turbine control device 1 in FIG. 2, and FIG. 4 is a flowchart of a turbine control method executed by the gas turbine control device 1 in FIG. 3.

In the gas turbine control devices 1, the automatic adjustment unit 20 includes an input unit 21, a state ascertaining unit 22, a frequency analysis unit 23, a correction amount calculation unit 24, a combustion state prediction unit 25, a database 26, and an output unit 28. These configurations function as follows when the gas turbine control method illustrated in FIG. 4 is executed.

First, various data transferred from the controller 10 (process amount, pressure, and acceleration which are output from the process amount measurement unit 4, the pressure fluctuation measurement unit 5, and the acceleration measurement unit 6 which are illustrated in FIG. 2) are input to the input unit 21 (Step S100). Various data input to the input unit 21 are delivered to the state ascertaining unit 22 and the frequency analysis unit 23 when necessary, and are used for various processes described later.

Subsequently, the frequency analysis unit 23 performs a frequency analysis on pressure fluctuations (measurement result of the pressure fluctuation measurement unit 5) or acceleration (measurement result of the acceleration measurement unit 6) in the various data acquired in Step S100 (Step S101). The frequency analysis in Step S101 is performed by applying Fast Fourier Transformation (FFT) to fluctuations in the pressure or the acceleration. A frequency analysis result obtained by the frequency analysis unit 23 is output to the state ascertaining unit 22 and the combustion characteristic ascertaining unit 25.

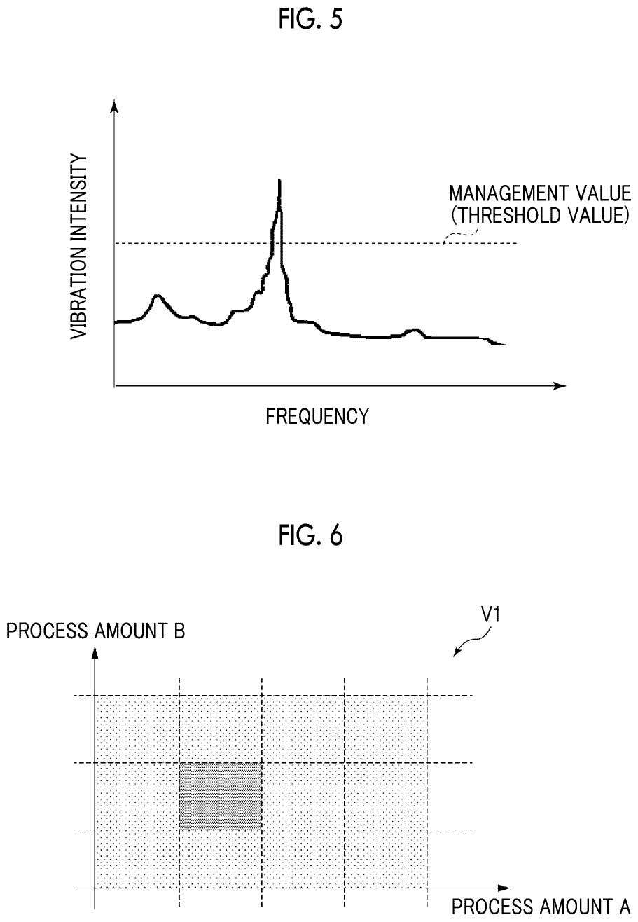

Here, FIG. 5 is an example of a result obtained by performing a frequency analysis on a pressure fluctuation in Step S101 in FIG. 4. In FIG. 5, a horizontal axis represents a frequency, and a vertical axis represents vibration intensity (level). As illustrated in FIG. 5, combustion vibration (pressure vibration or acceleration vibration) generated in the combustor 111 has a plurality of vibration frequencies. The frequency analysis may be performed by dividing the frequency into a plurality of frequency bands. Here, the frequency band is a frequency region which is a minimum unit for correspondence, based on a result obtained by the frequency analysis unit 23 performing the frequency analysis.

Subsequently, various data input in Step S100 and a frequency analysis result obtained in Step S101 are stored (added or updated) in the database 26 as analysis data (Step S102). The analysis data is stored to include the frequency analysis result at an operating point specified by the process amount included in the various data input in Step S100. As will be described later, a series of steps illustrated in FIG. 4 is repeatedly performed while the operating points are searched for, and the analysis data is sequentially stored in the database 26 for each operating point.

The analysis data accumulated in the database 26 in this way is used to construct a prediction model for predicting a combustion state of the gas turbine in the combustion state prediction unit 25. A method for constructing the prediction model is not limited, and a regression analysis or machine learning using the analysis data can be used.

Subsequently, it is determined whether or not a state of the gas turbine ascertained by the state ascertaining unit 22 deviates from a management range (Step S103). In the determination in Step S103, the state ascertaining unit 22 ascertains the state of the gas turbine, based on process values included in various data input in Step S100 and the frequency analysis result obtained in Step S101. The state is compared with a preset management range to determine whether or not the state deviates from the management range.

The state of the gas turbine ascertained by the state ascertaining unit 22 includes the presence or absence of the combustion vibration generated in the gas turbine, NOx or CO concentration contained in the exhaust gas from the gas turbine, or the combustion state of an accidental fire. In addition, the management range as a determination reference in Step S103 is defined by reference values (for example, an upper limit reference value and a lower limit reference value) corresponding to respective parameters indicating the states of the gas turbines. In an example in FIG. 5, the vibration intensity of the gas turbine is illustrated as an example of the state of the gas turbine. When the vibration intensity deviating from a management value (threshold value) which is the management range defined for the vibration intensity is detected, it can be determined that the combustion vibration is generated in the gas turbine. This management value may be set for each frequency band.

As a result, when it is determined that the state of the gas turbine deviates from the management range (Step S103: YES), the gas turbine control device 1 takes countermeasures so that the state of the gas turbine does not deviate from the management range (Step S104). For example, when the combustion vibration is generated due to a factor where the state of the gas turbine deviates from the management range, the countermeasure taken in Step S104 may be countermeasures for suppressing the combustion vibration such as adjustment of the flow rate of the fuel or the air (adjustment of an air-fuel ratio), or may be stopping the operation of the gas turbine 2.

On the other hand, when it is determined that the state of the gas turbine does not deviate from the management range (Step S103: NO), the gas turbine control device 1 determines whether or not the operating point is being searched for by the automatic adjustment unit 20 (Step S105). When the operating point is not being searched for (Step S105: NO), that is, when searching for the operating point starts from now, a past search result in an operating point region including a current operating point is checked (Step S106). In Step S106, for example, the analysis data stored in the database 26 is searched for. In this manner, the past search result is checked by searching past analysis data in the operating point region including the current operating point. More specifically, the past search result is checked, based on whether or not the analysis data stored in the database 26 has data included in the operating point region including a checking target operating point. More preferably, the past search result is checked, based on whether or not the analysis data stored in the database 26 has sufficient data for constructing a reliable prediction model in the operating point region.

In the present embodiment, the analysis data stored in the database 26 also serves as data for constructing the prediction model and reference data for checking the presence or absence of the past search result in the operating point region. However, the analysis data for constructing the prediction model and the reference data for checking the presence or absence of the past search result in the operating point region may be respectively stored in separate databases. That is, the database 26 may include a database for storing the analysis data for constructing the prediction model and a database for storing the reference data for checking the presence or absence of the past search result in the operating point region.

The operating point region handled in Step S106 is a range having a predetermined spread including a certain operating point. For example, when used as the analysis data used for constructing the prediction model, the operating point region is defined to include a range in which contributions to the operating point and the prediction model can be regarded as substantially equal, that is, a range which can be regarded as similar to a certain operating point.

Subsequently, the automatic adjustment unit 20 sets a waiting time included in a search start condition, based on the past search result checked in Step S106 (Step S107). The search start condition is a condition for starting the search for a search candidate point that is a subsequent movement destination candidate of the operating point in Step S109 (to be described later), and is defined under a condition that the waiting time set in Step S107 elapses.

The waiting time is set in Step S107 to become shorter as the number of data included in the operating point region including the operating point in the analysis data stored in the database 26 decreases. In this manner, collecting the analysis data in the operating point region having the small number of data is promoted. Accordingly, reliability of the prediction model constructed by using the analysis data can be effectively improved.

Subsequently, the automatic adjustment unit 20 determines whether or not the search start condition is satisfied as the waiting time set in Step S107 elapses (Step S108). When the search start condition is satisfied (Step S108: YES), a search candidate point is selected (Step S109). The search candidate point is selected as a movement destination candidate of the operating point, based on a predetermined search algorithm.

Subsequently, the combustion state prediction unit 25 predicts a combustion state for the search candidate point selected in Step S109 (Step S110). In Step S110, the combustion state when the operating point of the gas turbine shifts to the search candidate point is predicted by using the prediction model constructed by using the analysis data stored in the database 26. For example, the combustion state of the gas turbine which is predicted in Step S110 includes the presence or absence of the combustion vibration generated in the gas turbine, NOx or CO concentration contained in the exhaust gas from the gas turbine, and the presence or absence of an accidental fire.

Subsequently, the automatic adjustment unit 20 determines whether or not the combustion state predicted in Step S110 deviates from the management range (Step S111). The management range serving as a determination reference in Step S111 is defined by reference values (for example, an upper limit reference value and a lower limit reference value) corresponding to respective parameters indicating the combustion states of the gas turbines. That is, in Step S111, the combustion state predicted by the combustion state prediction unit 25 is determined to be substantially similar to Step S103 described above. In this manner, it is determined whether or not the combustion state at the search candidate point deviates from the management range.

As a result, when it is determined that the combustion state of the gas turbine at the search candidate point does not deviate from the management range (Step S111: YES), the automatic adjustment unit 20 commands the correction amount calculation unit 24 to output a correction value for shifting to the search candidate point searched for in Step S109 (Step S112). As a result, the operating point of the gas turbine shifts to the search candidate point searched for in Step S109, and the process returns to Step S100.

On the other hand, when it is determined that the combustion state of the gas turbine at the search candidate point deviates from the management range (Step S111: NO), the process returns to Step S113. In Step S113, it is determined whether or not a search end condition is satisfied. When the search end condition is not satisfied (Step S113: NO), the process proceeds to Step S109 to select the subsequent search candidate point. In this case, for the subsequent search candidate point as well, the analysis data used for constructing the prediction model is collected by moving the operating point within a range in which the combustion state of the gas turbine which is predicted by the combustion state prediction unit 25 does not deviate from the management range.

When the search end condition is satisfied (Step S113: YES), the operating point of the gas turbine returns to the point before the search (Step S114).

As described above, in this gas turbine control method, the above-described process is repeatedly performed. In this manner, while the operating point of the gas turbine moves to the search candidate point in which the combustion state does not deviate from the management range, the analysis data used for constructing the prediction model can be collected.

Here, in Step S107, the waiting time is set to be variable, based on the past search result in the operating point region including the operating point of the gas turbine. For example, when there is no past search result in the operating point region, a first waiting time is set as the waiting time. On the other hand, when there is the past search result in the operating point region, a second waiting time longer than the first waiting time is set as the waiting time. That is, when there is the past search result in the operating point region, the waiting time is set to be longer, compared to when there is no past search result.

When there is no past search result in the operating point region, the analysis data collected in the past for the operating point region is not stored in the database 26. Therefore, when the operating point of the gas turbine shifts to the search candidate point included in the operating point region, the analysis data is not stored in the database 26, and there is a high probability of obtaining data which greatly contributes to prediction accuracy when the prediction model is constructed. Therefore, in this case, the relatively short first waiting time is set as the waiting time. In this manner, it is possible to promote data collection in the operating point region where there is no past search result.

On the other hand, when there is the past search result in the operating point region, the analysis data collected in the past for the operating point region is stored in the database 26. Therefore, even when the operating point of the gas turbine shifts to the search candidate point included in the operating point region, the operating point is similar to the analysis data previously stored in the database 26, and there is a high probability of obtaining data which contributes less to prediction accuracy when the prediction model is constructed. Therefore, in this case, the relatively long second waiting time is set as the waiting time. In this manner, it is possible to suppress the collection of similar data in the operating point region where there is the past search result.

In addition, the operating point region which is a target for determining the presence or absence of the past search result for setting the waiting time in Step S107 may be defined in such a manner that a first virtual space V1 defined by the process amount of the gas turbine 2 is divided. Here, FIG. 6 is a view schematically illustrating the first virtual space V1 defined by the process amount of the gas turbine 2. In FIG. 6, the first virtual space V1 is defined as a two-dimensional space by two types of process amounts A and B, and is divided into a plurality of areas to correspond to a numerical range of the respective process amounts A and B. In this case, in Step S107, it is determined which area of the first virtual space V1 the operating point of the gas turbine belongs to, and the area to which the operating point belongs is specified as the operating point region (in FIG. 6, the area corresponding to the operating point region to which the operating point belongs is illustrated by dark hatching).

In FIG. 6, a two-dimensional space defined by two types of the process amounts A and B is illustrated as an example of the first virtual space V1. However, the first virtual space V1 may be a multi-dimensional space defined by more types of the process amounts.

In an example illustrated in FIG. 6, a case where the presence or absence of the past search result is determined in units of the area divided by the first virtual space V1 in Step S107 is illustrated as an example. However, the presence or absence of the past search result may be determined, based on a Euclidean distance to a value obtained by normalizing the operating state.

In addition, the waiting time may be set in Step S107, based on the number of data included in the past search result in the operating point region. In this case, when there is the past search result in the operating point region, the number of the analysis data stored in the database 26 is specified as the past search result. For example, the waiting time is set to be shortened as the number of the data decreases. The analysis data in the operating point region having a small number of the past search results greatly contributes to reliability improvement of the prediction model. Therefore, the short waiting time for the operating point having the small number of the data included in the past search result is set. In this manner, it is possible to promote collection of the analysis data in the operating point region.

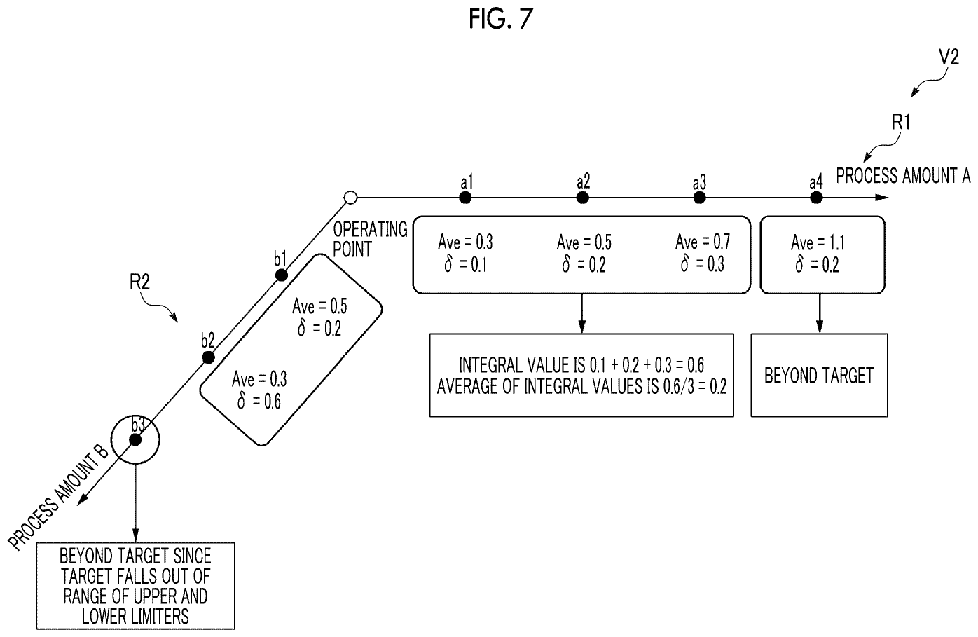

In addition, in selecting the search candidate point in Step S109, uncertainty o of the prediction model is evaluated for each search route settable in a second virtual space V2 defined by the process amount, and the search candidate point may be selected from the search route having a high uncertainty σ. In this case, each of the search routes settable in the second virtual space V2 may be defined as a route including the operating points in which the process amounts are different at a predetermined interval (for example, at an equal interval). Here, FIG. 7 is a view schematically illustrating the second virtual space V2 defined by the process amounts A and B of the gas turbine 2. In an example in FIG. 7, in the second virtual space V2, a first search route R1 (process amount B is fixed to zero) in which only the process amount A is changed at a regular interval, and a second search route R2 (process amount A is fixed to zero) in which only the process amount B is changed at a regular interval are illustrated.

The automatic adjustment unit 20 calculates the uncertainty σ for each operating point in the first search route R1 and the second search route R2. Specifically, operating points a1, a2, a3, a4, . . . and so on belong to the first search route R1. The operating point al has an average value p1=0.3 and a standard deviation σ1=0.1 for a process value A. The operating point a2 has an average value p2=0.5 and a standard deviation σ2=0.2 for the process value A. The operating point a3 has an average value p3=0.7 and a standard deviation σ3=0.3 for the process value A. The operating point a4 has an average value p4=1.1 and a standard deviation σ4=0.2 for the process value A. Here, when a preset allowable range (p<1.0) is defined for the process value A, uncertainty σA relating to the first search route R1 is obtained through the following equation by using the standard deviation of the operating points included in the allowable range.

$$σ A = ( σ1 + σ2 + σ3 ) / 3 = ( 0.1 + 0.2 + 0.3 ) / 3 = 0.2$$

Similarly, operating points b1, b2, b3, . . . , and so on belong to the second search route R2. The operating point b1 has an average value p1=0.5 and a standard deviation σ1=0.2 for a process value B. The operating point b2 has an average value p2=0.3 and a standard deviation σ2=0.6 for the process value B. Here, when the operating points b1 and b2 are included in a range of upper and lower limiters for the process value B, uncertainty σB for the second search route R2 is obtained through the following equation by using the standard deviation of the respective operating points.

$$σ B = ( σ1 + σ2 ) / 2 = ( 0.2 + 0.6 ) / 2 = 0.4$$

The automatic adjustment unit 20 compares the uncertainties σA and σB obtained for the first search route R1 and the second search route R2 in this way. In this manner, the automatic adjustment unit 20 preferentially selects the search candidate point from the search route having the high uncertainty. In this example, the uncertainty σB corresponding to the second search route R2 is higher than the uncertainty σA corresponding to the first search route R1. Therefore, the search candidate point is selected from the second search route R2 earlier than the first search route R1. In this way, the search candidate point is preferentially selected from the search route having the high uncertainty in the second virtual space V2. In this manner, it is possible to suitably collect the analysis data which greatly contributes to the improvement of the reliability of the prediction model.

In the present embodiment, a case where both the uncertainties σA and σB when the first search route R1 and the second search route R2 are compared are calculated as an average value of the standard deviations of the respective operating points belonging to the respective search routes has been described as an example. However, other references such as a maximum value or a minimum value may be compared for the standard deviation of the respective operating points belonging to the respective search routes.

In addition, in Step S112, when the correction value is output so that the operating point of the gas turbine 2 shifts to the search candidate point selected in Step S109, a change speed of a control signal with respect to the gas turbine 2 in accordance with the correction value may be changed to be variable. In this case, the change speed of the control signal may be set, based on at least one of behavior stability of the gas turbine from the current operating point to the search candidate point selected in Step S109, or the number of data included in the past search result in the operating point region including the current operating point.

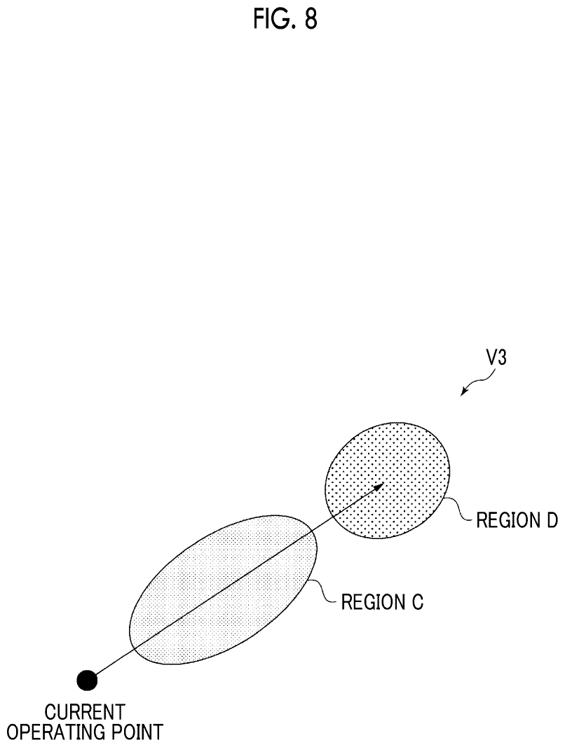

FIG. 8 is a view schematically illustrating a third virtual space V3 defined by the process amount of the gas turbine 2. In the third virtual space V3, a region C where the behavior stability of the gas turbine 2 is expected to be relatively high, based on a prediction result of the combustion state prediction unit 25, and a region D where the behavior stability of the gas turbine 2 is expected to be relatively low, based on the prediction result of the combustion state prediction unit 25 are illustrated as an example.

For example, in the region C, the behavior stability of the gas turbine 2 is high. Therefore, the correction amount per unit time is increased. In this manner, it is possible to increase the change speed of the control signal when the correction amount for shifting to the search candidate point selected in Step S109 is added. In this manner, in the region C where the behavior of the gas turbine 2 is expected to be stable, the change speed of the control signal is increased. In this manner, the operating point can quickly shift to the search candidate point serving as a shifting destination.

In addition, in the region D, the behavior stability of the gas turbine 2 is low. Therefore, the correction amount per unit time is decreased. In this manner, the change speed of the control signal can be decreased when the correction amount for shifting to the search candidate point searched for in Step S109 is added. In this manner, in the region D where the behavior stability is low, the change speed of the control signal is suppressed. In this manner, it is possible to reduce a probability that the behavior of the gas turbine 2 becomes unstable while the operating point shifts.

In addition, the change speed of the control signal when the operating point shifts over the regions C and D may further depend on the number of data included in the past search result in the operating point region including the operating point. For example, when the number of data included in the past search result in the operating point region is small, the change speed is increased. In this manner, it is possible to promote data collection in the operating point region having the small number of data. On the other hand, when the number of data included in the past search result in the operating point region is large, the change speed is decreased. In this manner, it is possible to achieve a cautious change which can further reduce the probability that the behavior of the gas turbine becomes unstable while the operating point shifts.

In addition, the change speed of the control signal with respect to the gas turbine 2 in accordance with the correction value may be set, based on the uncertainty of the prediction model at the search candidate point selected in Step S109. When the uncertainty of the prediction model at the search candidate point is equal to or greater than a reference value, the change speed of the control signal is increased. In this manner, the operating point can quickly shift to the search candidate point having the high uncertainty of the prediction model. Accordingly, the collection of the data which greatly contributes to the construction of the prediction model can be promoted. On the other hand, when the uncertainty of the prediction model at the search candidate point is smaller than the reference value, the change speed of the control signal is decreased. In this manner, a shifting speed of the operating point to the search candidate point having the low uncertainty is suppressed. Accordingly, it is possible to further reduce the probability that the behavior of the gas turbine becomes unstable while the operating point shifts.

As described above, according to each of the above-described embodiments, it is possible to provide the gas turbine control device and the gas turbine control method which can efficiently collect the analysis data used for constructing the prediction model for predicting the characteristics relating to the combustion stability of the gas turbine, while stably maintaining the operating state of the gas turbine.

In addition, it is possible to appropriately replace the components in the embodiment described above with well-known components within the scope which does not depart from the concept of the present disclosure, and the embodiments described above may be appropriately combined with each other.

For example, contents described in each of the above-described embodiments are understood as follows.

(1) The gas turbine control device according to an aspect includes the frequency analysis unit (23) for outputting the frequency analysis result by performing the frequency analysis on the vibration of the pressure or of the acceleration inside the combustor (111) of the gas turbine (2) at the operating points specified by the process amount of the gas turbine, the database (26) for storing the frequency analysis result and the process amount as the analysis data for each of the operating points, the combustion state prediction unit (25) for predicting the combustion state of the gas turbine using the prediction model constructed by using the analysis data, and the correction amount calculation unit (24) for calculating the correction amount to be added to the control signal of the gas turbine to operate the gas turbine at the search candidate point where the combustion state predicted by the state prediction unit falls within the management range, out of the search candidate points in which the operating point is the start point, when the search start condition that defines the lapse of the waiting time set based on the past search result in the operating point region including the operating point is satisfied.

According to the aspect (1) above, the result obtained by performing the frequency analysis on the vibration of the pressure or of the acceleration inside the combustor of the gas turbine is accumulated in the database as the analysis data for each of the operating points. The analysis data accumulated in the database is used for constructing the prediction model, and the prediction model is used for predicting the combustion state by the state prediction unit. The correction amount calculation unit determines that the search start condition is satisfied when the waiting time set based on the past search result at the operating point of the gas turbine elapses. When the search start condition is satisfied, the correction amount to be added to the control signal is calculated to operate the gas turbine at the search candidate point where the combustion state predicted by the combustion state prediction unit falls within the management range, out of the search candidate points in which the operating point is the start point. In this manner, the operating point of the gas turbine shifts to the search candidate point within a range in which the combustion state falls within the management range. Accordingly, new analysis data can be collected at the search candidate point.

(2) According to another aspect, in the aspect (1) above, when there is the past search result in the operating point region, the correction amount calculation unit is configured to set a second waiting time which is longer than a first waiting time corresponding to when there is no past search result in the operating point, as the waiting time.

According to the aspect (2) above, when the operating point region including the operating point has the past search result, the waiting time is set to be longer, compared to when there is no past search result. In this manner, the analysis data collected at the search candidate points in which the operating point belonging to the operating point region having the past search result is the start point relatively contributes less to the accuracy of the prediction model. Therefore, repeated collection of similar analysis data can be suppressed by setting the waiting time to be longer. On the other hand, the analysis data collected at the search candidate points in which the operating point belonging to the operating point region having no past search result is the start point greatly contributes to the accuracy of the prediction model. Therefore, collection can be promoted by setting the waiting time to be shorter.

(3) According to another aspect, in the aspect (1) or (2) above, the operating point region is specified as a region to which the operating point belongs out of a plurality of areas where a first virtual space defined by the process amount is divided.

According to the aspect (3) above, the operating point region in which the presence or absence of the past search result is determined is specified in units of the area where the first virtual space defined by the process value is divided. In this manner, the operating point region having a predetermined spread with respect to the operating point can be regarded as a similar range, and the waiting time can be set, based on the past search result in the operating point region.

(4) According to another aspect, in any one of the aspects (1) to (3) above, the waiting time is set to become shorter as the number of data included in the operating point region including the operating point out of the analysis data stored in the database decreases.

According to the aspect (4) above, the short waiting time is set for the operating point having the small number of data included in the operating point region including the operating point, out of the analysis data stored in the database. In this manner, the collection of the analysis data in the operating point region can be promoted. In this manner, the collection of the analysis data in the operating point region having the small number of data is promoted. Accordingly, the reliability of the prediction model constructed by using the analysis data can be effectively improved.

(5) According to another aspect, in any one of the aspects (1) to (4) above, the correction amount calculation unit is configured to evaluate uncertainty of the prediction model for each search route settable in a second virtual space defined by the process amount, and to preferentially select the search candidate point from the search route having the high uncertainty.

According to the aspect (5) above, the uncertainty of the prediction model is evaluated for each of the search routes settable in the second virtual space, and the search candidate point is preferentially selected from the search route having the high uncertainty. In this manner, the search candidate point is preferentially selected from the search route having the high uncertainty of the prediction model. Accordingly, the analysis data which greatly contributes to the improvement of the reliability of the prediction model can be efficiently collected.

(6) According to another aspect, in the aspect (5) above, the search route is defined as a route including the operating points where the process amounts are different at a predetermined interval in the second virtual space, and the correction amount calculation unit calculates the uncertainty of the search route, based on the uncertainty of the prediction model at each of the operating points included in the search route.

According to the aspect (6) above, the uncertainty of each search route is calculated, based on the uncertainty of each operating point included in each search route. In this manner, the uncertainty of each search route can be properly evaluated, based on the limited number of data.

(7) According to another aspect, in any one of the aspects (1) to (6) above, the correction amount calculation unit is configured so that a change speed of the control signal becomes variable by adding the correction amount, based on at least one of the number of data included in the past search result or stability of the combustion state predicted by the combustion state prediction unit at the search candidate point.

According to the aspect (7) above, when the correction amount is added to the control signal to operate the gas turbine at the search candidate point, the change amount of the control signal becomes variable, based on at least one of the number of data collected in the past in the operating point region or the stability of the combustion state at the search candidate point. In this manner, while the data is quickly collected, based on the contribution to the improvement of the reliability of the prediction model of the collected data and the stability of the combustion state when the operating point shifts to the search candidate point, a probability that the combustion state becomes unstable can be effectively reduced.

(8) According to another aspect, any one of the aspects (1) to (7) above further includes a state ascertaining unit (22) for ascertaining a state of the gas turbine at the operating point, based on the process amount.

The correction amount calculation unit stops calculating the correction amount, when the state ascertained by the state ascertaining unit deviates from the management range.

According to the aspect (8) above, when the state of the gas turbine which is ascertained by the state ascertaining unit deviates from the management range, searching for the operating point is stopped by adding the correction amount to the control signal. In this manner, it is possible to properly take countermeasures for restoring the state of the gas turbine to the management range.

(9) The gas turbine control method according to an aspect includes a step of outputting a frequency analysis result by performing a frequency analysis on vibration of a pressure or of acceleration inside a combustor of a gas turbine at operating points specified by a process amount of the gas turbine, a step of storing the frequency analysis result and the process amount in a database as analysis data for each of the operating points, a step of predicting a combustion state of the gas turbine by using a prediction model constructed by using the analysis data, and a step of calculating a correction amount to be added to a control signal of the gas turbine to operate the gas turbine at a search candidate point where the combustion state predicted by the state prediction unit falls within a management range, out of search candidate points in which the operating point is a start point, when a search start condition defining an elapse of a waiting time set based on a past search result in an operating point region including the operating point is satisfied.

According to the aspect (9) above, the result obtained by performing the frequency analysis on the vibration of the pressure or of the acceleration inside the combustor of the gas turbine is accumulated in the database as the analysis data for each of the operating points. The analysis data accumulated in the database is used for constructing the prediction model, and the prediction model is used for predicting the combustion state by the state prediction unit. The correction amount calculation unit determines that the search start condition is satisfied when the waiting time set based on the past search result at the operating point of the gas turbine elapses. When the search start condition is satisfied, the correction amount to be added to the control signal is calculated to operate the gas turbine at the search candidate point where the combustion state predicted by the combustion state prediction unit falls within the management range, out of the search candidate points in which the operating point is the start point. In this manner, the operating point of the gas turbine shifts to the search candidate point within a range in which the combustion state falls within the management range. Accordingly, new analysis data can be collected at the search candidate point.

### REFERENCE SIGNS LIST

1: Gas turbine control device
2: Gas turbine
4: Process amount measurement unit
5: Pressure fluctuation measurement unit
6: Acceleration measurement unit
7: Operation mechanism
10: Controller
20: Automatic adjustment unit
21: Input unit
22: State ascertaining unit
23: Frequency analysis unit
24: Correction amount calculation unit
25: Combustion state prediction unit
26: Database
28: Output unit
100: Gas turbine body part
101: Compressor
102: Inlet guide vane
103: Rotary shaft
104: Turbine
110: Combustion unit
111: Combustor
112: Compressed air introduction unit
113: Main fuel flow control valve
114: Pilot fuel flow control valve
115: Main fuel supply valve
116: Pilot fuel supply valve
117: Bypass air introduction pipe
118: Bypass valve
119: Bypass air mixing pipe
120: Combustion gas introduction pipe
121: Generator
V1: First virtual space
V2: Second virtual space
V3: Third virtual space

1-9. (canceled)

10. A gas turbine control device comprising:
a frequency analysis unit for outputting a frequency analysis result by performing a frequency analysis on vibration of a pressure or of acceleration inside a combustor of a gas turbine at operating points specified by a process amount of the gas turbine;
a database for storing the frequency analysis result and the process amount as analysis data for each of the operating points;
a combustion state prediction unit for predicting a combustion state of the gas turbine by using a prediction model constructed by using the analysis data; and
a correction amount calculation unit for calculating a correction amount to be added to a control signal of the gas turbine to operate the gas turbine at a search candidate point where the combustion state predicted by the state prediction unit falls within a management range, out of search candidate points in which the operating point is a start point, when a search start condition defining an elapse of a waiting time set based on a past search result in an operating point region including the operating point is satisfied.

11. The gas turbine control device according to claim 10,
wherein when there is the past search result in the operating point region, the correction amount calculation unit is configured to set a second waiting time which is longer than a first waiting time corresponding to when there is no past search result in the operating point, as the waiting time.

12. The gas turbine control device according to claim 10,
wherein the operating point region is specified as a region to which the operating point belongs out of a plurality of areas where a first virtual space defined by the process amount is divided.

13. The gas turbine control device according to claim 10,
wherein the waiting time is set to become shorter as the number of data included in the operating point region in the analysis data stored in the database decreases.

14. The gas turbine control device according to claim 10,
wherein the correction amount calculation unit is configured to evaluate uncertainty of the prediction model for each search route settable in a second virtual space defined by the process amount, and to preferentially select the search candidate point from the search route having the high uncertainty.

15. The gas turbine control device according to claim 14,
wherein the search route is defined as a route including the operating points where the process amounts are different at a predetermined interval in the second virtual space, and
the correction amount calculation unit calculates the uncertainty of the search route, based on the uncertainty of the prediction model at each of the operating points included in the search route.

16. The gas turbine control device according to claim 10,
wherein the correction amount calculation unit is configured so that a change speed of the control signal becomes variable by adding the correction amount, based on at least one of the number of data included in the past search result or stability of the combustion state predicted by the combustion state prediction unit at the search candidate point.

17. The gas turbine control device according to claim 10, further comprising:
a state ascertaining unit for ascertaining a state of the gas turbine at the operating point, based on the process amount,
wherein the correction amount calculation unit stops calculating the correction amount, when the state ascertained by the state ascertaining unit deviates from the management range.

18. A gas turbine control method comprising:
a step of outputting a frequency analysis result by performing a frequency analysis on vibration of a pressure or of acceleration inside a combustor of a gas turbine at operating points specified by a process amount of the gas turbine;
a step of storing the frequency analysis result and the process amount as analysis data for each of the operating points;
a step of predicting a combustion state of the gas turbine by using a prediction model constructed by using the analysis data; and
a step of calculating a correction amount to be added to a control signal of the gas turbine to operate the gas turbine at a search candidate point where the combustion state predicted by the state prediction unit falls within a management range, out of search candidate points in which the operating point is a start point, when a search start condition defining an elapse of a waiting time set based on a past search result in an operating point region including the operating point is satisfied.

19. The gas turbine control device according to claim 11, wherein the operating point region is specified as a region to which the operating point belongs out of a plurality of areas where a first virtual space defined by the process amount is divided.

20. The gas turbine control device according to claim 11,
wherein the waiting time is set to become shorter as the number of data included in the operating point region in the analysis data stored in the database decreases.

21. The gas turbine control device according to claim 11,
wherein the correction amount calculation unit is configured to evaluate uncertainty of the prediction model for each search route settable in a second virtual space defined by the process amount, and to preferentially select the search candidate point from the search route having the high uncertainty.

22. The gas turbine control device according to claim 11,
wherein the correction amount calculation unit is configured so that a change speed of the control signal becomes variable by adding the correction amount, based on at least one of the number of data included in the past search result or stability of the combustion state predicted by the combustion state prediction unit at the search candidate point.

23. The gas turbine control device according to claim 11, further comprising:
a state ascertaining unit for ascertaining a state of the gas turbine at the operating point, based on the process amount,
wherein the correction amount calculation unit stops calculating the correction amount, when the state ascertained by the state ascertaining unit deviates from the management range.
